(19) United States
(12) Patent Application Publication
(10) Pub. No.: US 2015/0331223 A1
(43) Pub. Date: Nov. 19, 2015

(54) OPTICAL LENS FOR IMAGE PICKUP

(71) Applicant: ALTEK CORPORATION, Hsinchu (TW)

(72) Inventor: Jui-Hsiung KUO, Kaohsiung City (TW)

(21) Appl. No.: 14/303,951

(22) Filed: Jun. 13, 2014

(30) Foreign Application Priority Data
May 14, 2014 (TW) 103116907

(51) Int. Cl. G02B 13/00; G02B 9/34

(52) U.S. Cl. CPC G02B 13/004; G02B 9/34

(57) ABSTRACT

This invention discloses an optical lens for image pickup, in order from an object-side to an image-side including a first lens, a second lens, a third lens and fourth lens. The first lens has positive refractive power. The second lens has negative refractive power. The third lens has positive refractive power. The fourth lens has negative refractive power with at least one inflection point on image-side surface. Wherein, each of the lenses has at least one aspheric surface. The optical lens for image pickup further includes an aperture stop and an image sensor. The aperture stop is disposed between the object and the second lens, and the image sensor is disposed at the image-plane. The optical lens for image pickup also satisfies with specific conditions.

### CROSS-REFERENCE TO RELATED APPLICATION

This application claims the benefit of Taiwan Patent Application No. 103116907, filed on May 14, 2014, in the Taiwan Intellectual Property Office, the disclosure of which is incorporated herein in its entirety by reference.

### BACKGROUND OF THE INVENTION

1. Field of the Invention

The present invention relates to an optical lens for image pickup, in particular with respect to an optical lens for image pickup consisted of four lenses which is suitable for electronic products, such as cell phones.

2. Description of the Related Art

As the technology is burgeoning, the mainstream of current electronic products' development becomes miniaturization, such as digital still camera, Web camera and mobile phone camera . . . etc., and the user not only needs image capturing lens of smaller and lower cost, but also with better field curvature correction capability, high resolution and high imaging quality.

In early stages, cell phone lens mostly utilizes mixture of glass lens and plastic lens, such as 1G (G: glass), 2P (P: plastic) or 1G3P, wherein regarding 1G2P, such as disclosure of U.S. Pat. No. 6,441,971, of which the first lens uses glass lens, and the second and third lenses use plastic lens, but the design is hard to achieve the current requirements of the necessitated miniaturization and low cost.

Additionally, the optical lens for image pickup embedded in small electronic product is two-piece, three-piece, four-piece and over five-piece that are conventional designs, but in terms of imaging quality, four-piece and five-piece image capturing lenses have advantages of field curvature correction and modulation transfer function (MTF). Among which, compared with five-piece lens, four-piece lens is of less number of lens, lower cost and is suitable for electronic products with the requirement of high pixel.

Moreover, with the rapid advancement of semiconductor technics, smaller pixel size is more likely to be used in portable video system and pixel of the optical sensor (CCD/CMOS) therefore is kept enhancing so that the increase of optical system's resolution is necessitated. Consequently, lens resolution of the traditional three-piece goes out of date, and for example, U.S. Pat. No. 7,365,920 disclosed that design of using cement glass lens to reduce field curvature so as to enhance the resolution is capable of promoting performance, but not easy to reduce its size.

Recently, because the manufacturing technic of plastic lens has been promoted, 3P structure has been used in downsized cell phone lens, such as U.S. Pat. No. 7,394,602 which disclosed a three-piece lens consisted of plastic; nonetheless, under the circumstance of image's pixel is demanded to be higher, 3P structure still has limitations such that the requirement of imaging quality while downsizing the optical sensor and enhancing pixel under the current trend cannot be satisfied.

Additionally, design of cell phone lens consisted of 4P structure is partially applied to the current market, such as U.S. Pat. No. 7,453,654 which disclosed the structure of four-piece plastic lens, but in terms of structure of the normal four-piece lens, FOV angle is usually of about 60°-70° which is limited to the need for ultra wide angle lens.

As a result, the present invention provides a more practical design which while reducing optical image capturing lens, using combination of refractive power, convex and concave surfaces of four lenses can not only effectively shorten the total length of optical image capturing lens, but also further promote imaging quality so as to lower manufacturing cost by a simple lens shape and consequently may be apply to electronic products, such as cell phones and so on.

### SUMMARY OF THE INVENTION

The primary objective of the present invention is to provide an optical lens for image pickup, in order from an object-side to an image-side including: a first lens having positive refractive power; a second lens having negative refractive power; a third lens having positive refractive power; a fourth lens having negative refractive power and at least one inflection point on the image-side surface thereof; an aperture stop disposed between an object and the second lens; and an image sensor disposed on an image-plane; wherein, each lens includes at least one aspheric surface, and they satisfy the following relations:

1.3<TTL/f<1.8 (1), and

0.8<Y1/f<0.98 (2)
wherein, a distance between the object-surface of the first lens to the image-plane is TTL (as shown in FIG. 7), a focal length of the optical lens for image pickup is f, a light ray from the object-side and having an incident angle of 45 degrees with respect to an optical axis and passing through a center of the aperture stop intersects the image-plane at a point, a perpendicular distance from the point to the optical axis is Y1 (as shown in FIG. 7).

On the other hand, the present invention provides an optical lens for image pickup as aforementioned, wherein, each lens is made of plastic, object-side surface of the first lens is a convex surface, object-side surface and image-side surface of the second lens are a concave, the second and fourth lenses have negative refractive powers, and preferably, image-side surface of the fourth lens is concave surface, and the aperture stop is disposed at the object-side of the first lens; other than relations (1) and (2), the optical lens for image pickup can further satisfy with the following relations:

0.5<f1/f3<2 (3), and

28<|v1−v2|<42 (4)

wherein, a focal length of the first lens is f1 and a focal length of the third lens is f3; an Abbe number of the first lens is v1 and an Abbe number of the second lens is v2.

By arranging the aforementioned first, second, third and fourth lenses on the optical axis with an adequate gap, the present invention can effectively reduce the total length of optical lens and has advantages of field curvature correction and Modulation Transfer Function (MTF).

In the optical lens for image pickup of the present invention, a first lens having positive refractive power provides most necessary refractive power for the optical system which contributes to the reduction of the total length of the optical system; a second lens may be a biconcave lens having negative refractive power which is able to correct the field curvature accompanied and partial outer axis field curvature with the first lens; by arranging a third lens having positive refractive power, it can thereby promote the necessary refractive power for optical system to disperse the refractive power of the first lens so as to reduce error sensitivity to the optical system and contribute to manufacture; furthermore, a fourth lens having negative refractive power is used to concentrate light on an image-plane so that the image-plane is not bent so as to reach to purpose of high resolution as well as requirement of being projected on the image sensor with a specific incident angle.

Regarding the optical lens for image pickup of the present invention, an aperture stop arranged at the object-side of the first lens is called a pre-treating aperture stop. The arrangement of the aperture stop enables a longer distance between the exit pupil and the image-plane of the optical lens for image pickup. Besides, image may be received by the image sensor element via way of direct injection, and vignetting effect may thereby be avoided. Such a result is called telecentric effect of object-side. Generally, the telecentric effect can enhance the brightness of the image-plane and the image-receiving efficiency of CCD or CMOS of the image sensor can be increased as well.

Additionally, the object-side surface of the first lens may be a convex surface which benefits enlarging field perspective of the optical lens for image pickup and being moderated towards the reflection of incident light ray to prevent the field curvature increasing excessively, so that it benefits to have a perfect balance between enlargement of the field perspective of the optical lens for image pickup and the field curvature correction. If the image-side surface of the second lens is a concave surface, it can effectively increase the back focal length of the optical lens for image pickup to ensure that the optical lens for image pickup has sufficient back focal length to place other elements; preferably, the object-side surface of the second lens may also be a concave surface. Furthermore, the object-side surface of the fourth lens may be a concave surface which enables the principle point of the optical lens for image pickup away from the image-plane and benefits from reducing the total optical length of the optical lens for image pickup and contributes to downsize the lens.

In addition, each lens may be formed of plastic which benefits from manufacturing as well as reducing cost.

### BRIEF DESCRIPTION OF THE DRAWINGS

FIG. 1 is a schematic diagram of an optical system of the first embodiment concerning an optical lens for image pickup of the present invention.

FIG. 2 is a curve diagram of field curvature and distortion of the first embodiment concerning an optical lens for image pickup of the present invention.

FIG. 3 is a curve diagram of longitudinal aberration of the first embodiment concerning an optical lens for image pickup of the present invention.

FIG. 4 is a schematic diagram of an optical system of the second embodiment concerning an optical lens for image pickup of the present invention.

FIG. 5 is a curve diagram of field curvature and distortion of the second embodiment concerning an optical lens for image pickup of the present invention.

FIG. 6 is a curve diagram of longitudinal aberration of the second embodiment concerning an optical lens for image pickup of the present invention.

FIG. 7 is a schematic diagram of TTL and Y1 of an optical lens for image pickup of the present invention.

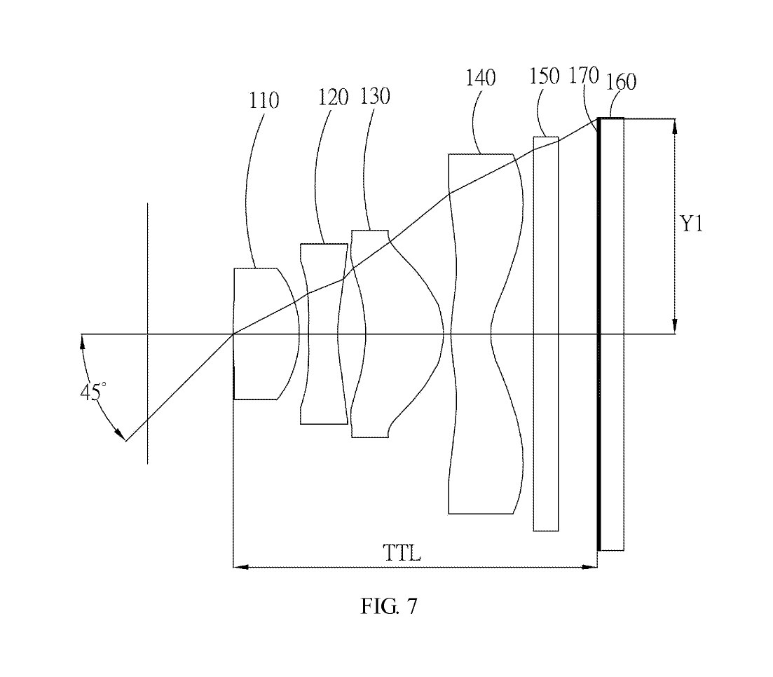

### DETAILED DESCRIPTION OF THE PREFERRED EMBODIMENTS

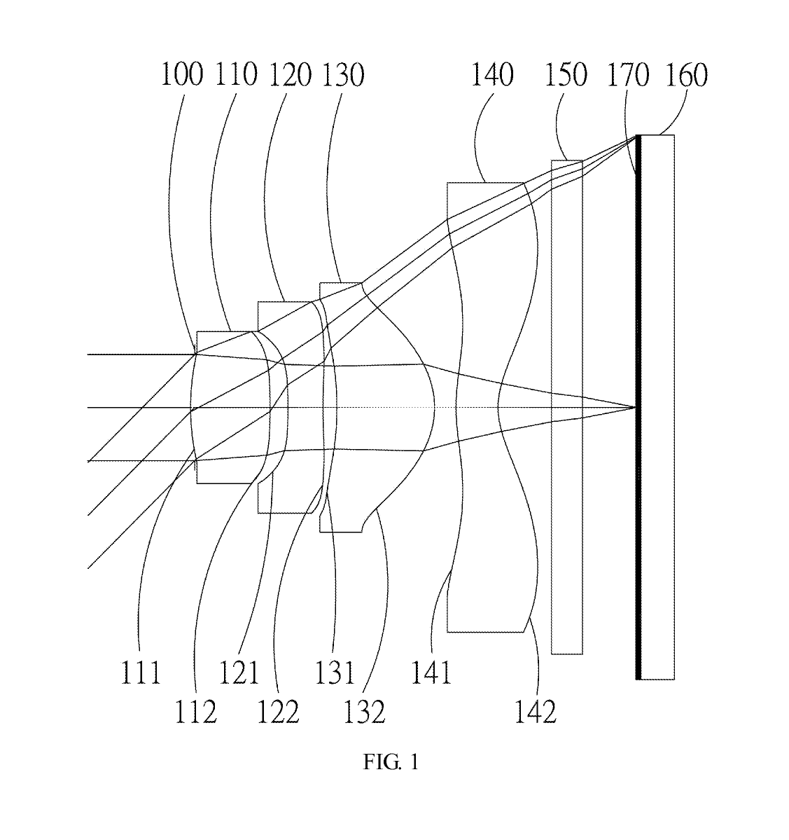

The present invention provides an optical lens for image pickup. Please refer to FIG. 1, an optical lens for image pickup in order from an object-side to an image-side including: a first lens 110, a second lens 120, a third lens 130 and a fourth lens 140; wherein the first lens 110 has positive refractive power, the second lens 120 has negative refractive power, the third lens 130 has positive refractive power and the fourth lens 140 has negative refractive power and at least one inflection point on the image-side surface 142 thereof. The optical lens for image pickup further includes an aperture stop 100, an IR filter 150 and an image sensor 160. The aperture stop 100 may be disposed between the second lens 120 and an object (not shown), and is the pre-treating aperture stop or a center aperture stop. The IR filter 150 is disposed between the fourth lens 140 and an image-plane 170 and is usually made of optical plate materials, such that the focal length f of the optical lens of the present invention would not be affected. The image sensor 160 is disposed on the image-plane 170 and can pick up images of the object (not shown). Each of the lenses 110, 120, 130 and 140 may include at least one aspheric surface. The equation of aspherical surface formula is expressed as follows:

$$X ( Y ) = \frac{( {Y}^{2} / R )}{1 + \sqrt{( 1 - ( 1 + K ) {( Y / R )}^{2} )}} + {\sum }_{i} ( {A}_{i} ) \cdot ( {Y}^{i} ) , \qquad ( 5 )$$

wherein:
X: the height of a point on the aspheric surface at a distance Y from the optical axis relative to the tangential plane at the aspheric surface vertex;
Y: the distance from the point on the curve of the aspheric surface to the optical axis;
K: the conic coefficient;
Ai: the aspheric coefficient of order i.

Nonetheless, in the optical lens for image pickup of the present invention, surfaces of the four lenses 110, 120, 130 and 140 may be spherical or aspheric. While aspheric is used, it is able to modify refractive power of the lens by changing the surface's shape so as to lower aberration and reduce total length of the optical lens. Consequently, by the arrangement of the four lenses 110, 120, 130 and 140, the optical lens for image pickup of the present invention, the relations (1) to (4) may be satisfied.

When formula (1) is satisfied, the volume of the optical lens for image pickup may be reduced effectively. On the other hand, if parameters of the optical lens exceed an upper limit of formula (1), the volume of the optical lens for image pickup may be difficult to be reduced; if parameters of the optical lens exceed a lower limit of formula (1), the structure of the optical lens for image pickup may cause difficulties in the producing and manufacturing process. In addition, when the formula (2) is further satisfied, it is ensured that the optical lens for image pickup can have sufficient field angle so as to satisfy with the need for ultra wide angle.

In order to achieve miniaturization in size and reduction in sensitivity, the formula (3) is preferably to be satisfied, such that the refractive power of the first lens 110 may be effectively distributed so as to accomplish downsizing and increase the productivity. Otherwise if parameters of the optical lens exceed an upper limit of the formula (3), it causes the increase of sensitivity of the first lens 110; and if parameters of the optical lens exceed a lower limit of the formula (3), the volume of the lens thereof may be difficult to be downsized.

When the formula (4) is satisfied, it enables the difference between the Abbe number v1 of the first lens 110 and the Abbe number v2 of the second lens 120 may fall within an adequate range, which is able to effectively correct the field curvature caused by the first and second lenses 110, 120, so as to reach to the purpose of effectively correcting field curvature and thereby promote optical property.

The optical lens for image pickup of the present invention will be explicitly described by the following embodiments accompanying with the drawings.

Please refer to FIG. 1 which is a schematic diagram of an optical system of the first embodiment concerning an optical lens for image pickup of the present invention. As illustrated in the figure, the optical lens for image pickup, in order from an object-side to an image-side may include: the first lens 110, the second lens 120, the third lens 130 and the fourth lens 140. Wherein the first lens 110 has positive refractive power and may be made of plastic, the object-side surface 111 thereof may be a convex surface and the image-side surface 112 thereof may be a convex surface. The second lens 120 has negative refractive power and may be made of plastic, the object-side surface 121 thereof may be a concave surface and the image-side surface 122 thereof may be a concave surface. The third lens 130 has positive refractive power and may be made of plastic, the object-side surface 131 thereof may be a concave surface and the image-side surface 132 thereof maybe a convex surface. The fourth lens 140 has negative refractive power and may be made of plastic, the object-side surface 141 thereof may be a concave surface and the image-side surface 142 thereof may be a concave surface. The aperture stop 100 may be disposed at the object-side of the first lens 110. The IR filter 150 is disposed between the fourth lens 140 and the image-plane 170. The image sensor 160 is disposed on the image-plane 170.

The optical data of the optical lens for image pickup of the present embodiment is shown as following [symbol] Table 1-1 [symbol] :

TABLE 1-1
F: 1.3 mm, Fno: 2.6, FOV/2: 45 deg

| Sur- | | | thick- | | | | Focal |
|---|---|---|---|---|---|---|---|
| face | | radius | ness | material | index | Abbe# | length |
| 0 | Object | Plane | infinity | | | | |
| 1 | Aperture | Plane | −0.025 | | | | |
| | stop | | | | | | |
| 2 | First lens | 1.060 | 0.372 | Plastic | 1.54 | 55.93 | 1.59 |
| 3 | | −4.281 | 0.084 | | | | |
| 4 | Second | −4.608 | 0.164 | Plastic | 1.64 | 23.97 | −2.16 |
| 5 | lens | 2.005 | 0.065 | | | | |
| 6 | Third | −1.469 | 0.457 | Plastic | 1.54 | 55.93 | 0.83 |
| 7 | lens | −0.385 | 0.100 | | | | |
| 8 | Fourth | 0.800 | 0.197 | Plastic | 1.54 | 55.93 | −1.27 |
| 9 | lens | 0.340 | 0.250 | | | | |
| 10 | IR filter | Plane | 0.145 | Glass | 1.517 | 64.2 | — |
| 11 | | Plane | 0.25 | | | | |
| 12 | Image- | Plane | — | | | | |
| | plane | | | | | | |

Each surface of each lens of the present embodiment may be aspheric surface as an aspect, but it shall not subject to this restriction. The object-side surfaces and the image-side surfaces of the first lens 110, the second lens 120, the third lens 130 and the fourth lens 140 are all satisfy with the aspherical formula (5), and the aspherical coefficients are shown as following [symbol] Table 1-2 [symbol] :

TABLE 1-2
Aspherical Coefficients

| Surface | 2 | 3 | 4 | 5 |
|---|---|---|---|---|
| K | −7.9892E+00 | 8.2857E+01 | 1.5688E+02 | −1.0045E+02 |
| A4 | 1.1138E+00 | −3.8180E+00 | −6.8758E+02 | −2.1814E+00 |
| A6 | −2.3013E+01 | −7.3809E+00 | −1.2975E+01 | 3.4628E+00 |
| A8 | 2.0004E+02 | 1.1506E+02 | −3.9528E+01 | 4.0621E+01 |
| A10 | 7.1696E+02 | −1.3860E+03 | 1.1579E+03 | 7.6175E+01 |
| A12 | −2.1686E+04 | 15.3743E+03 | −1.6000E+02 | −2.6774E+03 |
| A14 | −4.0888E+05 | 1.0989E+04 | −1.1853E+02 | 8.6904E+03 |
| A16 | 4.8929E+06 | −1.8943E+05 | −2.2411E+05 | −8.5100E+03 |
| Surface | 6 | 7 | 8 | 9 |
| K | −1.9863E+00 | −1.7332E+00 | −2.2693E+01 | −3.6769E+00 |
| A4 | −9.6060E−01 | −1.5387E+00 | −1.2963E+00 | −1.3805E+00 |
| A6 | 3.7207E+00 | 5.5387E+00 | 2.0438E+00 | 3.6916E+00 |
| A8 | 1.2045E+02 | −3.0406E+01 | 1.0506E+00 | −7.4228E+00 |
| A10 | −9.9408E+20 | 1.0201E+02 | −9.4420E+00 | 1.0969E+01 |
| A12 | 3.4557E+03 | −1.3128E+02 | 1.5493E+01 | −8.5763E+00 |
| A14 | −8.0406E+03 | 5.0590E+02 | −1.0982E+01 | 4.0700E+00 |
| A16 | 1.0011E+04 | −9.2063E+02 | 2.9044E+00 | −8.1268E−01 |

In the optical lens for image pickup of the present embodiment, the definition of each variable (f, f1, f3, TTL, Y1, v1 and v2) and the relation therebetween can be seen in preceding description, the unnecessary details are no longer given in the embodiment. The configuration of these variables may be found in following [symbol] Table 1-3 [symbol] :

TABLE 1-3

| TTL (mm) | f | TTL/f |
|---|---|---|
| 2.080 | 1.300 | 1.600 |
| Y1 | f | Y1/f |
| 1.251 | 1.300 | 0.962 |
| f1 | f3 | f1/f3 |
| 1.590 | 0.830 | 1.916 |
| v1 | v2 | \| v1 − v2 \| |
| 55.930 | 23.970 | 31.960 |

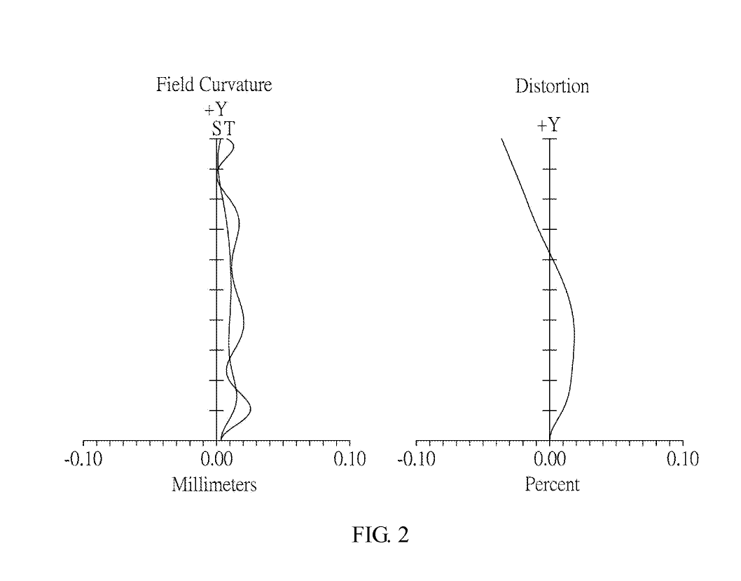

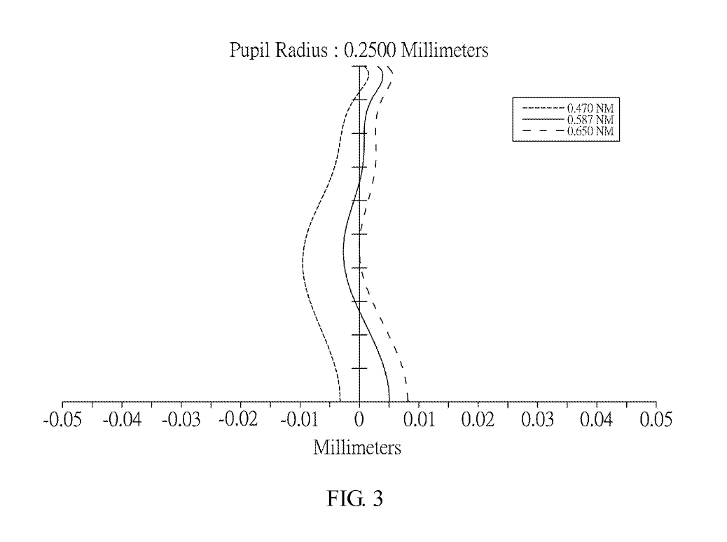

As illustrated in tables 1-1 and 1-3 along with FIGS. 2 and 3, the embodiment of the optical lens for image pickup of the present invention shows perfect compensation effect on longitudinal spherical aberration, astigmatic field curving and distortion.

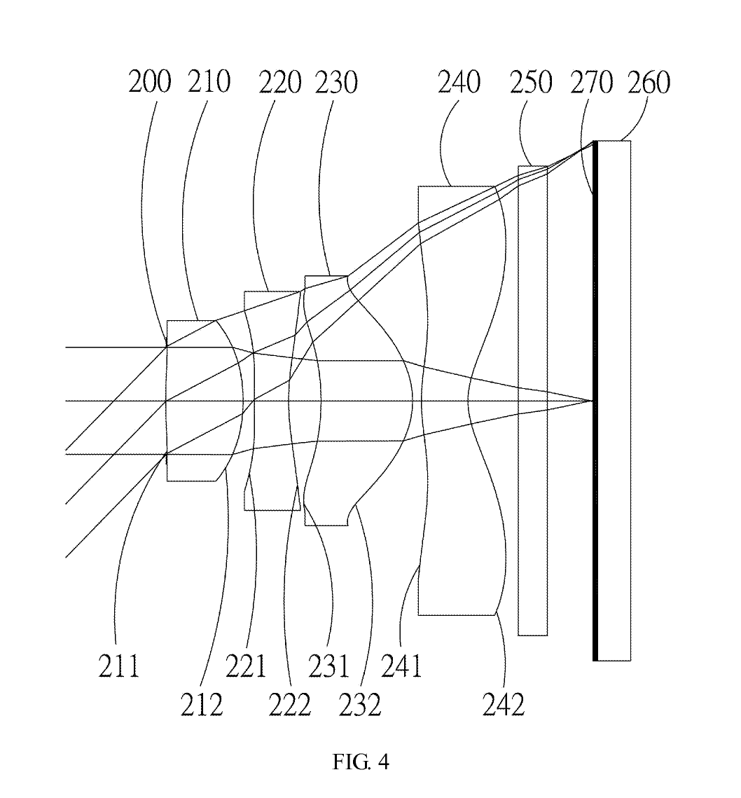

Please refer to FIG. 4 which is a schematic diagram of an optical system of the second embodiment concerning an optical lens for image pickup of the present invention. As illustrated in this figure, the optical lens for image pickup has four lenses having refractive power, in order from an object-side to an image-side, may include: the first lens 210, the second lens 220, the third lens 230 and the fourth lens 240. Wherein the first lens 210 has positive refractive power and may be made of plastic, the object-side surface 211 thereof may be a convex surface and the image-side surface 212 thereof may be a convex surface. The second lens 220 has negative refractive power and may be made of plastic, the object-side surface 221 thereof may be a concave surface and the image-side surface 222 thereof may be a concave surface. The third lens 230 has positive refractive power and may be made of plastic, the object-side surface 231 thereof may be a concave surface and the image-side surface 232 thereof may be a convex surface. The fourth lens 240 has negative refractive power and may be made of plastic, the object-side surface 241 thereof may be a concave surface and the image-side surface 242 thereof may be a concave surface. The aperture stop 200 may be disposed at the object-side of the first lens 210. The IR filter 250 is disposed between the fourth lens 240 and the image-plane 270. The image sensor 260 is disposed on the image-plane 270.

The optical data of the optical lens for image pickup of the present embodiment is shown as following [symbol] Table 2-1 [symbol] :

TABLE 2-1
F: 1.298 mm, Fno: 2.5, FOV/2: 45 deg

| Sur- | | | thick- | | | | Focal |
|---|---|---|---|---|---|---|---|
| face | | radius | ness | material | index | Abbe# | length |
| 0 | Object | Plane | infinity | | | | |
| 1 | Aperture | Plane | −0.007 | | | | |
| | stop | | | | | | |
| 2 | First lens | 2.772 | 0.384 | Plastic | 1.54 | 55.93 | 1.21 |
| 3 | | −0.822 | 0.056 | | | | |
| 4 | Second | 3.656 | 0.171 | Plastic | 1.64 | 23.97 | −2.12 |
| 5 | lens | 0.959 | 0.161 | | | | |
| 6 | Third | −1.077 | 0.456 | Plastic | 1.54 | 55.93 | 0.97 |
| 7 | lens | −0.408 | 0.044 | | | | |
| 8 | Fourth | 0.840 | 0.231 | Plastic | 1.54 | 55.93 | −1.34 |
| 9 | lens | 0.352 | 0.250 | | | | |
| 10 | IR filter | Plane | 0.145 | Glass | 1.52 | 64.2 | — |
| 11 | | Plane | 0.227 | | | | |
| 12 | Image- | Plane | — | | | | |
| | plane | | | | | | |

Each surface of each lens of the present embodiment may be aspheric as an aspect, but it shall not subject to this restriction. The object-side surfaces and the image-sides surface from the first lens 210, the second lens 220, the third lens 230 and the fourth lens 240 all satisfy of the aspherical formula (5), and the aspherical coefficients are shown as following [symbol] Table 2-2 [symbol] :

TABLE 2-2
Aspherical Coefficients

| Surface | 2 | 3 | 4 | 5 |
|---|---|---|---|---|
| K | 1.8656E+00 | 1.1911E−01 | 2.2162E+01 | −2.7598E+01 |
| A4 | −4.9093E−01 | −3.4395E+00 | −5.6960E+00 | −1.5756E−01 |
| A6 | −2.4324E+01 | 2.3548E+01 | 3.6606E+01 | −2.1377E+00 |
| A8 | 3.6765E+02 | −1.0662E−01 | −1.1804E+02 | 4.8069E+00 |
| A10 | −2.1764E+03 | −1.3661E+03 | 1.3847E+02 | 2.2771E+02 |
| A12 | 1.5960E+04 | 6.8939E+03 | −1.9640E+03 | −2.2536E+03 |
| A14 | −7.5347E+05 | 3.4422E+03 | 1.8777E+04 | 8.3331E+03 |
| A16 | 6.8839E+06 | −7.2119E+04 | −4.5836E+04 | −1.0981E+04 |
| Surface | 6 | 7 | 8 | 9 |
| K | 2.5007E+00 | −1.0557E+00 | −2.4579E+01 | −3.5749E+00 |
| A4 | −1.9572E−01 | −1.9326E−01 | −1.2043E+00 | −1.38.0E+00 |
| A6 | −4.6525E+00 | 4.7333E+00 | 1.7389E+00 | 3.6909E+00 |
| A8 | 1.3257E+02 | −3.2784E+01 | 2.2127E+00 | −7.2592E+00 |
| A10 | −8.9588E+02 | 1.0308E+02 | −1.0411E+01 | 9.7393E+00 |
| A12 | 3.6229E+03 | −1.2017E+02 | 1.3845E+01 | −8.1983E+00 |
| A14 | −7.8531E+03 | 3.5508E+02 | −8.1581E+00 | 3.8281E+00 |
| A16 | 6.9597E+03 | −6.3359E+02 | 1.7734E+00 | −7.5008E−01 |

In an optical lens for image pickup of the present embodiment, the definition of each variable (f, f1, f3, TTL, Y1, v1 and v2) and the relation therebetween can be seen in preceding description, the unnecessary details are no longer given in the embodiment. The configuration of these variables may be found in following [symbol] Table 2-3 [symbol] :

TABLE 2-3

| TTL (mm) | f | TTL/f |
|---|---|---|
| 2.125 | 1.298 | 1.637 |
| Y1 | f | Y1/f |
| 1.253 | 1.298 | 0.965 |
| f1 | f3 | f1/f3 |
| 1.210 | 0.97 | 1.247 |
| v1 | v2 | \| v1 − v2 \| |
| 55.930 | 23.970 | 31.960 |

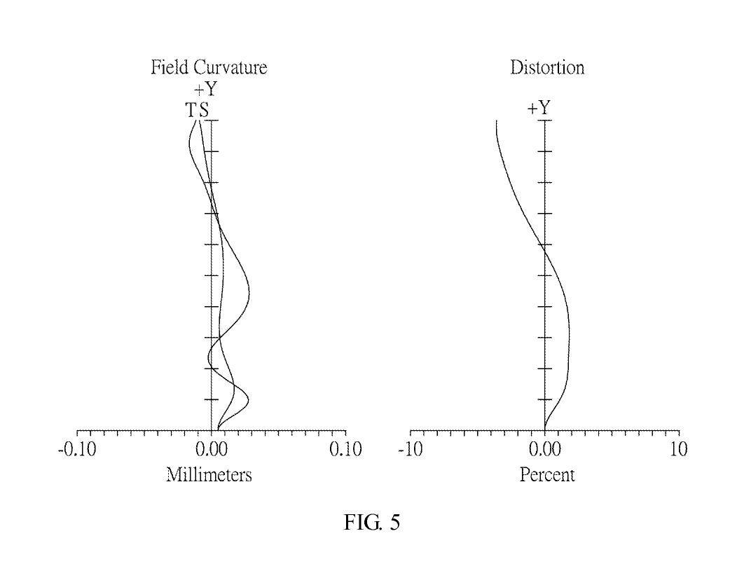

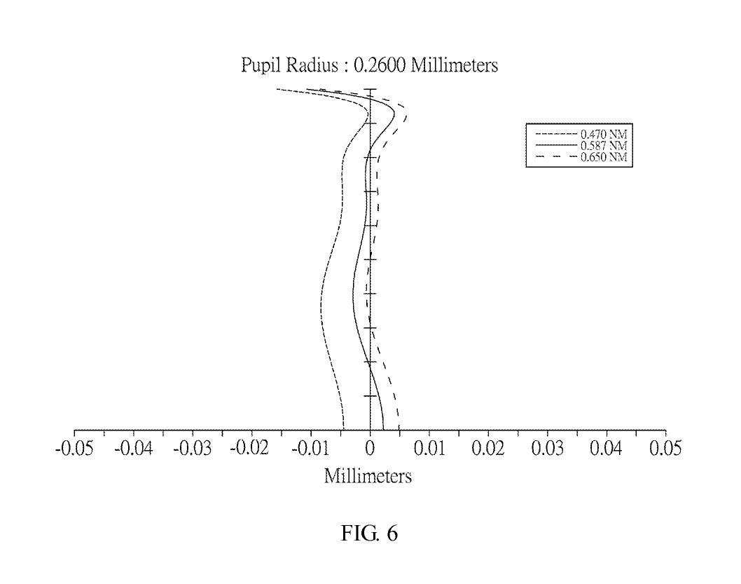

As illustrated in tables 2-1 and 2-3 along with FIGS. 5 and 6, the embodiment of the optical lens for image pickup of the present invention shows perfect compensation effect on longitudinal spherical aberration, astigmatic field curving and distortion.

In addition, if an inflection point is disposed on the fourth lens, it guides the angle of image light which emits at edge of the fourth lens so that the angle of the image light of off-axis visual field is guided to the image sensor and is received by the image sensor.

In the optical lens for image pickup of the present invention, the material of the lens may be glass or plastic. If the lens is made of glass, the freedom of arranging refractive power of the optical lens for image pickup may be increased; if the lens is made of plastic, the manufacturing cost may thereby be reduced. In addition, an aspheric can be disposed on the lens surface which benefits from manufacturing shapes other than spherical and acquires more control variables to reduce field curvature so as to decrease the amount of lens. Consequently, the total length of the optical lens for image pickup may be significantly reduced in accordance with the present invention.

In the optical lens for image pickup of the present invention, if the lens surface is convex, it means that the lens surface on the paraxial position is a convex surface; if the lens surface is a concave surface, it means that the lens surface on the paraxial position is a concave surface.

The tables 1-1 to 2-3 indicate the different numerical variations of the optical lens for image pickup of the present invention, but each variation of the embodiments of the present invention is the experimental outcome, even though using different numerical values, products of the same structure still belong to protective scope of the present invention. Therefore, the aforementioned description and drawings are merely used as exemplary examples, not to limit to the claims of the present invention.

What is claimed is:

1. An optical lens for image pickup, in order from an object-side to an image-side comprising:
a first lens having positive refractive power;
a second lens having negative refractive power;
a third lens having positive refractive power;
a fourth lens having negative refractive power and at least one inflection point on the image-side surface thereof;
an aperture stop disposed between an object and the second lens; and
an image sensor disposed on an image-plane;
wherein, each lens comprises at least one aspheric surface, and a distance between the objective-surface of the first lens to the image-plane is TTL, a focal length of the optical lens for image pickup is f, a light ray from the object-side and having an incident angle of 45 degrees with respect to an optical axis and passing through a center of the aperture stop intersects the image-plane at a point, a perpendicular distance from the point to the optical axis is Y1, and they satisfy the following relations:
1.3<TTL/f<1.8, and
0.8<Y1/f<0.98.

2. The optical lens for image pickup as defined in claim 1, wherein the image-side surface of the fourth lens is a concave surface.

3. The optical lens for image pickup as defined in claim 1, wherein the object-side surface of the first lens is a convex surface.

4. The optical lens for image pickup as defined in claim 3, wherein the aperture stop is disposed at the object-side of the first lens.

5. The optical lens for image pickup as defined in claim 1, wherein the image-side surface of the second lens is a concave surface.

6. The optical lens for image pickup as defined in claim 5, wherein the object-side surface of the second lens is a concave surface.

7. The optical lens for image pickup as defined in claim 1, wherein a focal length of the first lens is f1, a focal length of the third lens is f3, and they satisfy the following relation:
0.5<f1/f3<2.

8. The optical lens for image pickup as defined in claim 1, wherein an Abbe number of the first lens is v1, an Abbe number of the second lens is v2, and they satisfy the following relation:
28<|v1−v2|<42.

9. The optical lens for image pickup as defined in claim 1, wherein the first, the second, the third and the fourth lenses are made of plastic.
